(19) United States
(12) Patent Application Publication
(10) Pub. No.: US 2015/0221176 A1
(43) Pub. Date: Aug. 6, 2015

(54) ELECTRONIC GAMING MACHINE AND GAMING METHOD

(71) Applicant: Ainsworth Game Technology Limited, Newington (AU)

(72) Inventors: Jason Meyer, Abbotsford (AU); Pairatch Paotrakul, Panania (AU)

(21) Appl. No.: 14/613,832

(22) Filed: Feb. 4, 2015

(30) Foreign Application Priority Data
Feb. 5, 2014 (AU) 2014900339
Jul. 11, 2014 (AU) 2014902685

(51) Int. Cl. G07F 17/32; G07F 17/34

(52) U.S. Cl. CPC G07F 17/3258; G07F 17/34

(57) ABSTRACT

An electronic gaming machine has a display and an electronic game controller for displaying a game of chance, where at least a first betting option and a second betting option are selectable by a player. Each betting option has a respective unique bet value associated with participation in the game. At least one win multiplier value is randomly determined from a plurality of predetermined win multiplier values. At least one winning event is associated with a winning combination, wherein the player receives a prize calculated by the randomly determined win multiplier value multiplied by a predetermined prize award associated with the winning combination. A theoretical average multiplier value associated with the first betting option is different to a theoretical average win multiplier value associated with the second betting option. Alternatively, the randomly determined win multiplier value is varied based on the selected betting option. A gaming method is also provided.

### BACKGROUND

The invention relates to an electronic gaming machine and in a particular an electronic gaming machine employing a base game and a feature game. The invention has been developed primarily for use as an electronic gaming machine and will be described hereinafter by reference to this application. The invention may additionally apply to games of chance operated or adapted for use with electronic gambling machines.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may be provided by an electronic gaming machine in addition to the base or main game. Typically feature games use the same set of reels as the main game and are limited to a set of free games operated under a single set of rules. Once the free feature games have been played, the electronic gaming machine resets itself and returns the player back to the base game.

Also, electronic gaming machines can offer one or more bonus prizes to the player during play of the game. The most common type of bonus prize that is awarded by the electronic gaming machine is a jackpot prize, the main example of which is a progressive jackpot prize. A progressive jackpot prize takes a portion of each bet (typically a set percentage of each bet) made on the electronic gaming machine and thus the amount of the progressive jackpot inclemently increases as more bets are made on the electronic gaming machine. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

This standard structure to game play and bonus prizes limits the variation in the play of the electronic gaming machine. Consequently, it is difficult to retain player interest because there is no apparent incentive for the player to continue playing the same electronic gaming machine once the player becomes familiar with the feature game and the main game. Also, it is difficult to retain player interest since there is little differentiation between gaming machines in terms of the main and feature games that are played.

It is an object of the invention to overcome or substantially ameliorate one or more of the disadvantages of prior art, or at least to provide a useful alternative.

It is an object of the invention in at least one preferred form to provide an electronic gaming machine and a method for controlling an electronic gaming machine that encourages player interest.

### SUMMARY

According to a first aspect of the invention, there is provided an electronic gaming machine adapted for playing a game of chance, comprising:

a display for displaying said game of chance, and

an electronic game controller for controlling the display of said game of chance on said display, wherein said game of chance comprises:
at least a first betting option and a second betting option selectable by a player, wherein each said betting option has a respective unique bet value associated with participation in the game;
at least one win multiplier value determined at random by said electronic game controller from a plurality of predetermined win multiplier values;
at least one winning event associated with a winning combination, wherein the player receives a prize calculated by: the randomly determined win multiplier value being multiplied by a predetermined prize award associated with the winning combination, and
wherein a theoretical average multiplier value associated with said first betting option is different to a theoretical average win multiplier value associated with said second betting option.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

A second aspect of the present invention provides an electronic gaming machine comprising:

a housing having a display for displaying a game of chance;

an electronic game controller in electronic communication with said display for controlling the display of said game of chance on said display; and

an input device for receiving commands from said player to operate said electronic gaming machine and initiate play of said game on said display, said input device being in electronic communication with said electronic game controller;

wherein said electronic game controller in response to a command from said player via said input device transmits a signal to said display to display said game of chance, said command comprising a selection of at least one of a first betting option and a second betting option, each said betting option having a respective unique bet value associated with participation in the game;

wherein said electronic game controller randomly determines at least one win multiplier value from a plurality of predetermined win multiplier values;

wherein said electronic game controller associates at least one winning event with a winning combination, wherein the player receives a prize calculated by: the randomly determined win multiplier value being multiplied by a predetermined prize award associated with the winning combination; and

wherein a theoretical average multiplier value associated with said first betting option is different to a theoretical average win multiplier value associated with said second betting option.

According to a third aspect of the invention, there is provided an electronic gaming machine adapted for playing a game of chance comprising:

a display for displaying said game of chance, and

an electronic game controller for controlling the display of said at least one game of chance on said display, wherein said game of chance comprises:
at least a first betting option and a second betting option selectable by a player, wherein each betting option has a respective bet value associated with participation in the game,
at least one win multiplier value determined at random by said electronic game controller from a plurality of predetermined win multiplier values;
at least one winning event, wherein the player receives a prize and wherein the prize is calculated by said randomly determined win multiplier value multiplied by a predetermined prize award, and
wherein the randomly determined win multiplier value is varied based on the selected betting option.

A fourth aspect of the present invention provides an electronic gaming machine comprising:

a housing having a display for displaying a game of chance;

an electronic game controller in electronic communication with said display for controlling the display of said game of chance on said display; and

an input device for receiving commands from said player to operate said electronic gaming machine and initiate play of said game on said display, said input device being in electronic communication with said electronic game controller;

wherein said electronic game controller in response to a command from said player via said input device transmits a signal to said display to display said game of chance, said command comprising a selection of at least one of a first betting option and a second betting option, each said betting option having a respective unique bet value associated with participation in the game;

wherein said electronic game controller randomly determines at least one win multiplier value from a plurality of predetermined win multiplier values;

said game of chance comprising at least one winning event wherein the player receives a prize calculated by said randomly determined win multiplier value multiplied by a predetermined prize award; and

wherein said electronic game controller varies the randomly determined win multiplier value based on the selected betting option.

According to a fifth aspect of the invention, there is provided a gaming method for playing a game of chance on an electronic gaming machine comprising a display for displaying said game of chance and an electronic game controller for controlling the display of said game of chance on said display, the method comprising the steps of:

providing at least a first betting option and a second betting option to be selectable by a player;

providing each said betting option with a respective unique bet value associated with participation in the game;

said electronic game controller randomly determining at least one win multiplier value from a plurality of predetermined win multiplier values;

associating at least one winning event with a winning combination, wherein the player receives a prize, and

calculating said prize by: multiplying the randomly determined win multiplier value by a predetermined prize award associated with the winning combination,

wherein a theoretical average multiplier value associated with said first betting option is different to a theoretical average win multiplier value associated with said second betting option.

A sixth aspect of the present invention provides a gaming method for an electronic gaming machine comprising a housing having a display for displaying a game of chance; an electronic game controller inside said housing for controlling the display of said game of chance on said display; and an input device for receiving commands from said player to operate said electronic gaming machine, said input device being in electronic communication with said electronic game controller, the method comprising:

said electronic game controller receiving a command from said player via said input device to initiate play of said game on said display, said command comprising a selection of at least a first betting option and a second betting option;

said electronic game controller providing each said betting option having a respective unique bet value associated with participation in the game;

said electronic game controller randomly determining at least one win multiplier value from a plurality of predetermined win multiplier values;

said electronic game controller associating at least one winning event with a winning combination, wherein the player receives a prize; and

said electronic game controller calculating said prize by: multiplying the randomly determined win multiplier value by a predetermined prize award associated with the winning combination;

wherein a theoretical average multiplier value associated with said first betting option is different to a theoretical average win multiplier value associated with said second betting option.

The method of the sixth aspect of the invention preferably has the preferred features of the fourth aspect of the invention stated above, where applicable.

According to a seventh aspect of the invention, there is provided a gaming method for playing a game of chance on an electronic gaming machine comprising a display for displaying said game of chance and an electronic game controller for controlling the display of said game of chance on said display, the method comprising the steps of:

providing at least a first betting option and a second betting option to be selectable by a player;

providing each said betting option with a respective unique bet value associated with participation in the game;

said electronic game controller randomly determining at least one win multiplier value from a plurality of predetermined win multiplier values;

associating at least one winning event with a winning combination, wherein the player receives a prize;

calculating said prize by: multiplying the randomly determined win multiplier value by a predetermined prize award associated with the winning combination, and

varying the randomly determined win multiplier value based on the selected betting option.

An eighth aspect of the present invention provides a gaming method for an electronic gaming machine comprising a housing having a display for displaying a game of chance; an electronic game controller inside said housing for controlling the display of said game of chance on said display; and an input device for receiving commands from said player to operate said electronic gaming machine, said input device being in electronic communication with said electronic game controller, the method comprising:

said electronic game controller receiving a command from said player via said input device to initiate play of said game on said display, said command comprising a selection of at least a first betting option and a second betting option;

said electronic game controller providing each said betting option having a respective unique bet value associated with participation in the game;

said electronic game controller randomly determining at least one win multiplier value from a plurality of predetermined win multiplier values;

said electronic game controller associating at least one winning event with a winning combination, wherein the player receives a prize;

said electronic game controller calculating said prize by: multiplying the randomly determined win multiplier value by a predetermined prize award associated with the winning combination; and

said electronic game controller varying the randomly determined win multiplier value based on the selected betting option.

According to a ninth aspect of the invention, there is provided a computer system comprising a central processing unit configured for communication with an electronic gaming machine, wherein said computer system is configured to perform the method of any one of the fourth to eighth aspects of the invention.

According to a tenth aspect of the invention, there is provided a computer program configured to perform the method of any one of the fourth to eighth aspects of the invention.

According to a eleventh aspect of the invention, there is provided a non-transitory carrier medium carrying computer executable code that, when executed on a central processing unit configured for communication with an electronic gaming machine, causes the central processing unit to perform the method of any one of the fourth to eighth aspects of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a simulated screen shot of an electronic game controller for the electronic gaming machine of FIG. 1, and

FIGS. 3 to 8 are simulated screen shots illustrating a game played on the electronic gaming machine of FIG. 1.

### DETAILED DESCRIPTION OF VARIOUS EMBODIMENTS

The present invention will now be described with reference to the following examples which should be considered in all respects as illustrative and non-restrictive. In the Figures, corresponding features within the same embodiment or common to different embodiments have been given the same reference numerals.

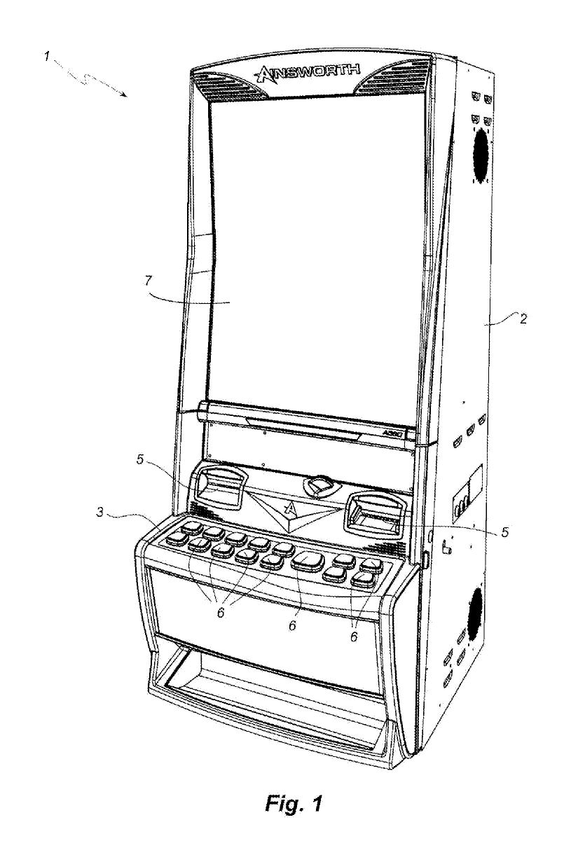

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with another type of value transfer mechanism, such as a value input/value output device, a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value. Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

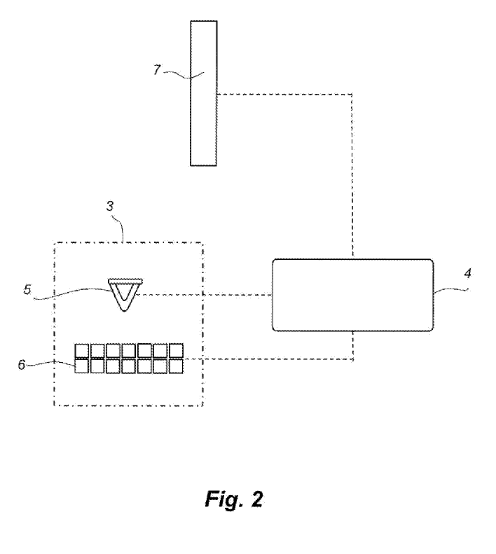

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store program instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1

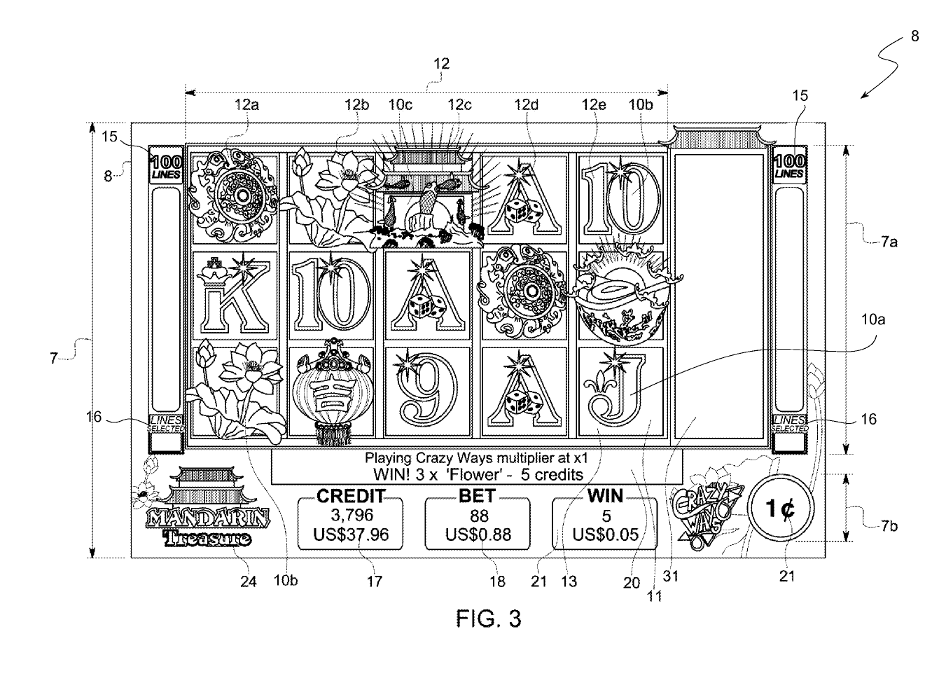

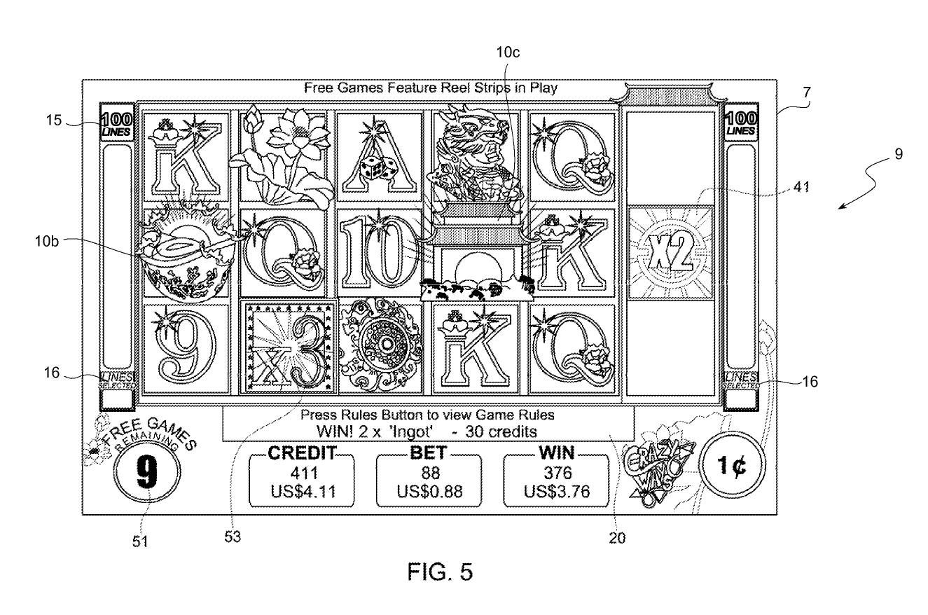

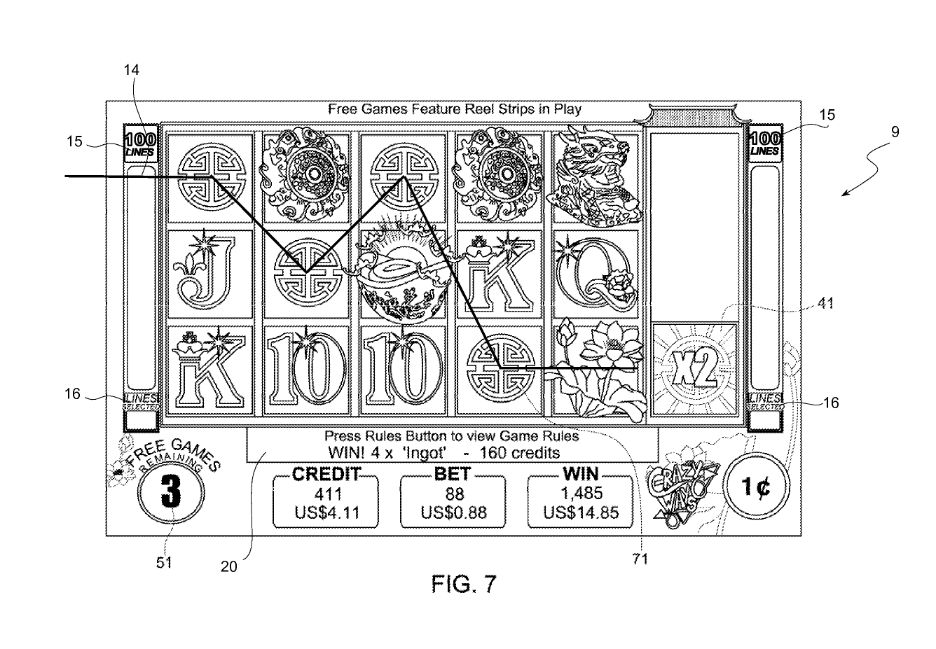

The electronic game controller 4 is programmed to provide a game in the form of a base game 8, as best shown in FIGS. 3, 6 and 8, and a feature game 9 (as best shown in FIGS. 5 and 7) on the video display screen 7 of the electronic gaming machine 1 for play by a player. The video display screen 7 is divided into a lower playing area 7a and an upper information display area 7b.

The base game 8 has game symbols 10 arranged into an array 11 in the form of five columns or “reels” 12 that are displayed in the lower playing area 7a, as best shown in FIG. 3. The reels 12 give the visual appearance of rotating, typically by having the game symbols 10 move in a downward linear path along the length of each reel 12. While the primary array 11 is arranged with five reels 12a, 12b, 12c, 12d, 12e and three rows as per the industry standard, it will be appreciated by one skilled in the art that other types of arrays and array formats could be used, such as 3×3, 4×3, 5×5, 4×4, etc., including arrays having an irregular number of rows and/or columns. For example, the primary array 11 can have an unequal number or rows and/or columns, where some columns have less or more rows than other columns or where some rows have less or more columns than other rows. A more specific example would be an array having three columns with only two rows and two columns with three rows. Another example would be an array having five reels of which two reels only have three rows while three reels have four rows. In some embodiments, the array 11 has an irregular shape. The electronic game controller 4 will transmit signals to the display screen 7 to cause the base game 8 and feature game 9 to be played on the lower playing area 7a, including showing the game symbols 10, array 11 and other visible elements of the games.

The array 11 of the base game 8 defines predetermined game or symbol positions 13, in which the game symbols 10 randomly selected by the electronic game controller 4 appear. The symbol positions 13 are not visually marked by boundary lines and simply provide an area for the game symbols 10 to appear. However, it will be appreciated that in other embodiments, the symbol positions 13 are defined by visible boundary lines or other markings to define each respective area of the symbol positions, such as a square or game position.

The primary array 11 is arranged so that a player can select one or more predetermined “pay lines” 14 defined around the array, which correspond to combinations of the game or symbol positions 13. The pay lines 14 correspond to the lines selected by the player and generally comprise at least one game position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player. In the feature game 9, predetermined winning combinations of randomly selected game symbols 10 also result in the award of prizes to the player, usually of an enhanced value compared to the prizes awarded in the base game 8.

The game symbols 10 can include a mixture of picture symbols (such as animal symbols or playing card symbols), word symbols, scatter symbols, substitute or wild card symbols and trigger symbols to trigger the feature game 9. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In this embodiment, the game symbols 10 include playing card symbols 10a, Asian themed characters, Asian themed pictures or item-themed symbols 10b, substitute or wild card symbols in the form of a symbol 10c, a scatter symbol in the form of symbol (not shown) and a trigger symbol (not shown). The electronic game controller 4 randomly determines and causes the appearance of the game symbols 10 on the array 11 in the game positions 13 of the reels 12.

Further the embodiment shown in FIG. 3 has an additional multiplier reel 31 that forms part of the array 11 and is adjacent to the base game reels 12. The additional multiplier reel 31 displays a plurality of win multiplier symbols that have associated win multiplier values, which are preferably predetermined about a theoretical average value as discussed in more detail below. The additional multiplier reel 31 rotates or spins when a play of the game is initiated and stops to display one or more win multiplier symbols that confer their respective associated win multiplier values upon the player as discussed in more detail below. Preferably, the win multiplier value for every spin or play of the base game 8 is set a minimum value of 1, although the respective symbol for the 1× multiplier value may or may not be shown based on the aesthetic appearance of the game. Additionally, win multiplier symbols are revealed by the additional multiplier reel 31. In this embodiment, multiplier reel 31 does not include game symbols, however further variations of this embodiments may include game symbols on this reel.

The embodiment shown in FIG. 3 shows no win multiplier symbols on the additional multiplier reel 31 and therefore the win multiplier value is set at a minimum value of X1. Where a win event is determined by a winning combination being displayed on the array 11 when being compared to the game rules, the normal predetermined prize award (as per the paytable) is multiplied by at least one win multiplier value.

Preferably, the win multiplier values are varied in accordance of the theoretical average multiplier value which is calculated based on the respective betting option chosen by the player. For example, the higher or larger the bet on each game, the higher or larger the theoretical average multiplier value would be generated. The player has the opportunity to receive larger win multiplier values when larger bet options are made for a particular game.

Preferably, the betting option or betting value chosen by the player does not vary the prize awarded for a winning combination but rather the winning combination is simply awarded as per the paytable multiplied by win multiplier values shown displayed on the winning combination screen. For example, if the player chooses a one credit bet for one payline and receives a 2X win multiplier value and a winning combination of game symbols that deliver a 2 credit predetermined prize award from the paytable. The 2 credit predetermined prize award would be multiplied by 2 giving a final calculated prize of 4 credits.

Theoretically, if the player increased the betting option or value to 4 credits, the electronic game controller 4 would adjust the theoretical average of the win multiplier values giving a greater array of win multiplier values. A greater array of win multiplier values may mean either or a combination of the following: a larger count of win multiplier values; and/or a greater theoretical average value of all of the possible win multiplier values. Given the same predetermined prize award as the previous example of 2 credits and a new higher win multiplier value may be shown (for example ×4), the final prize may be 2 credits multiplied by 4 as shown on the win multiplier value.

Preferably, modifying or changing the betting options or betting values made by players in respect of a particular game, may not amend the final prize payout but rather the final prize payout is modified by the win multiplier values shown on the screen.

The video screen 7 also displays other standard game information in the lower playing area 7b, including the number of pay lines available 15, the number of player-selected pay lines 16, the amount of player credits 17, the amount of the current bet wagered by the player 18, the amount of wins by the player 19, a message area 20, a denomination button 21 indicating the currently selected base bet denomination, message strip 22 associated with the denomination button 21, a menu button (not shown) for bringing up a menu screen (typically explaining the game rules and showing the available pay lines 14) and the name 24 of the game “Mandarin Treasure” being played. The embodiment is within the “Crazy Ways” series of game of chance of which “Mandarin Treasures” is one of many.

In the base game 8, the player initially makes a bet using vending slots 5 initiate play of the electronic gaming machine 1 to build up credit to play the base game on the electronic gaming machine. The player can bet or wager monetary amounts equivalent to a particular amount of credits, depending on the bet denomination selected for the base game. For example, the player can bet or wager 50 credits to play 10 pay lines or 200 credits to play 50 pay lines. Also, the player can make any additional side bets or ante-bets to access additional features in the base game 8, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc. Preferably, the base bet denominations of the base game 8 are 1¢, 2¢, 5¢ and 10¢.

Typically, the electronic gaming machine has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game 8, which would be the 1¢ bet denomination for this embodiment. The default bet denomination is shown on the denomination button 21 to indicate its current status. The player may change the base bet denomination at any time in the base game 8 by touching the denomination button 21 before or after the reels 12 have spun.

The electronic game controller 4 then transmits a signal to the display 7 so as to cause the reels 12 to appear to visibly rotate or “spin” in a linear path, typically in a downward vertical direction, and randomly display the game symbols 10 in each game position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

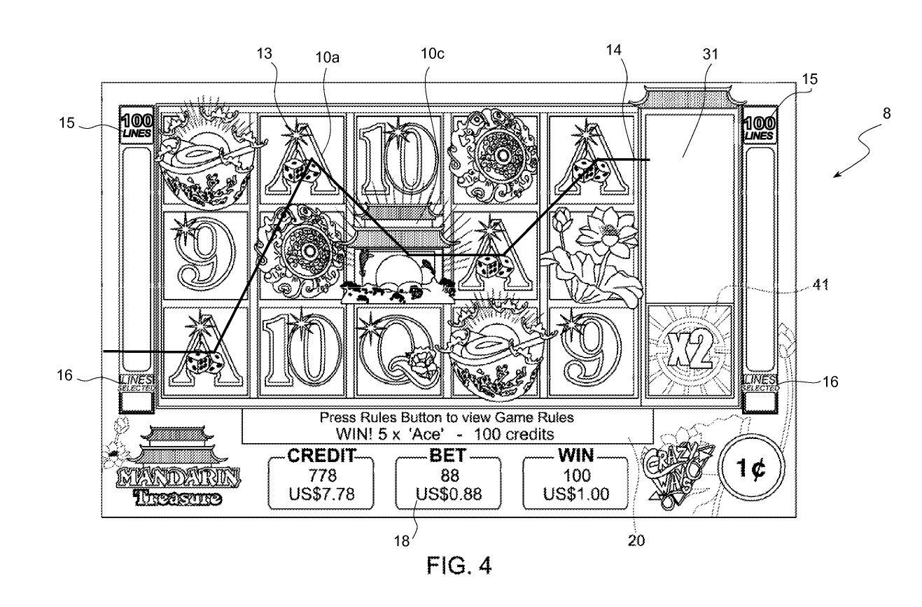

Referring now to FIG. 4, the upper display region 7a depicts a winning combination of 4 ace symbols 10a with a wild card symbol 10c along pay line 14. According to the paytable, this predetermined winning combination provides the prize of 50 credits. The actual prize awarded in this embodiment is 100 credits as the predetermined prize amount of 50 credits was multiplied by the X2 win multiplier symbol 41 as shown on multiplier reel 31. The final prize amount was determined without direct regard to the amount that was bet or wagered as shown in box 18. The details of the prize award are displayed to the player in the message box 20.

Referring now to FIG. 5, where corresponding features have been given the same reference numerals, the invention is applied to a feature game 9 instead of a base game. In this embodiment the display 7 shows a winning combination of 1 ingot symbol 10b along with a wild card symbol 53. Preferably, the wild card symbol 53 may flash or flicker between two images wherein a first image is that of randomised win multiplier and a second image is the standard wild card symbol 10c. In this embodiment, the win multiplier image 53 is shown to be an X3 win multiplier value.

In this embodiment, the total prize award is shown in the message box 20 as being 30 credits. This prize award was calculated by multiplying the predetermined prize award (derived from the paytable for a winning combination of 2 ingots) of 5 credits and then multiplying by the win multiplier symbol 53 (being X3) and then the ×2 win multiplier symbol 41. This result generates a prize award of 30 credits—that is, 5 credits×3 (×3 win multiplier symbol 53)×2 (win multiplier symbol 41)=30 credits.

In this embodiment, all of the win multiplier values shown on the screen have been multiplied together. However other methods of combining the values are also possible wherein all of the win multiplier symbols are added together and then multiplied with the predetermined prize award. In regard to this variation, the final prize award shown in the message box would be reduced to 25 credits rather than 30 credits—that is, 5 credits×5 (×3+×2)=25 credits.

Generally, the electronic game controller 4 randomly determines whether a predetermined trigger event has occurred which triggers the feature game 9 on the electronic gaming machine 1. The feature game may be triggered by the appearance of three trigger symbols in any of the symbol positions 13 of the reels 12 on the player-selected pay lines 14. In other embodiments, the trigger event is the appearance of three trigger symbols anywhere on the reels 12 without having to be on a player-selected pay line 14; i.e. the trigger symbols act as scatter symbols in this instance. In response to the feature game trigger event, the electronic game controller 4 transmits a signal to the video screen 7 to cause the feature game 9 to appear on the video screen 7. The feature game 9 typically uses the same game symbols 10 as the base game 8, as well as the same array 11, reels 12, symbol positions 13 and player-selectable pay lines 14 on the video screen 7.

In the feature game 9, a predetermined number of free plays or spins of the feature game are awarded to the player. It will be understood by those skilled in the art that a free spin involves a play of the game without requiring any bet to be made by the player, and that any number of free spins can be chosen for the feature game 9. In addition, it will be appreciated that in the art free spins are commonly referred to as “free games”. In this case, the reels 12 in the feature game 9 are spun without requiring the player to make a bet, unlike the base game. The number of free spins left in the feature game 9 is usually indicated in a counter in the lower display area 7a. The feature game 9 would operate in a similar manner to the base game 8, where the reels 12 visibly rotate and display randomly selected game symbols 10 in each symbol position 13. Predetermined winning combinations of randomly selected game symbols 10 in the reels 12 of the feature game would also result in the award of prizes to the player, usually of an enhanced value compared to the prizes awarded in the base game 8.

Preferably, the game may also include a feature game 9 wherein free spins may be awarded for certain predetermined trigger event combinations or symbols. In the embodiment of the feature game 9 shown in FIG. 5, a free spin indicator 51 has been shown at the bottom or lower portion of the screen. The number shown in the indicator 51 depicts the number of free spins remaining for the player to play without incurring a wager. In this embodiment, 9 free spins are indicated by the indicator 51.

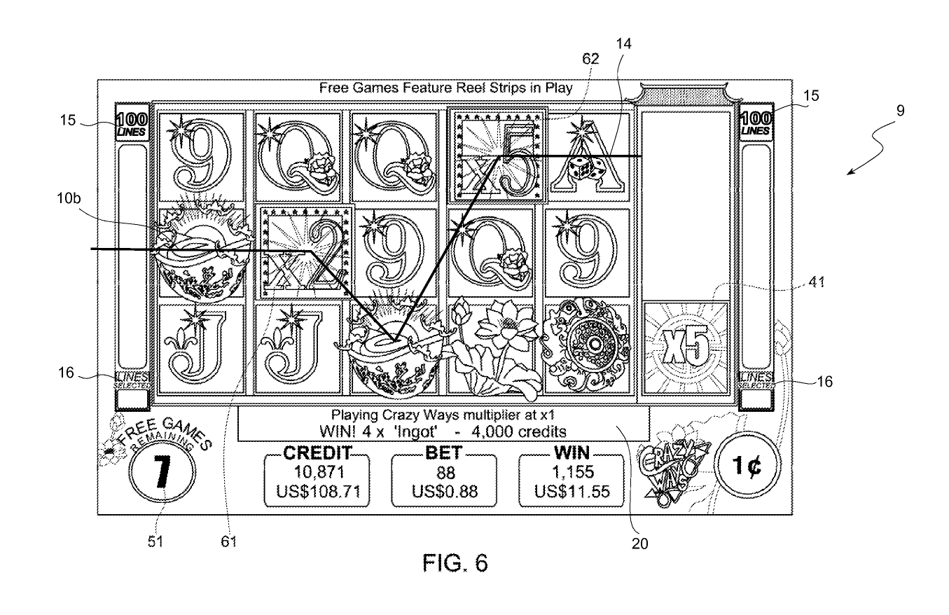

Referring to FIG. 6, where corresponding features have been given the same reference numerals, this embodiment shows a base game result wherein a 4 ingot combination has been awarded that includes two wild card symbols 61 and 62 and two ingot symbols 10b. Also, a further win multiplier symbol 41 is also shown on the additional multiplier reel 31. In this embodiment, all of the win multiplier symbols 61, 62, and 41 are multiplied together with the predetermined prize award for the combination of 4 ingots from the paytable. In this example, the predetermined prize award is 80 credits multiplied by X2 and X5 and X5, which in turn yields a total or final prize award of 4000 credits as shown in the message box 20.

Referring to FIG. 7, where corresponding features have been given the same reference numerals, this embodiment depicts a winning combination of 4 ingot game symbols 71 which yields a predetermined prize award of 80 credits. An X2 win multiplier symbol is shown on multiplier reel 31 and therefore the final prize award will be 160 credits as shown in message box 20.

In this embodiment, the ingot game symbols 71 also flicker or flash intermittently to show both the ingot image and a pictogram image. The screenshot of the game as depicted in FIG. 7 shows the pictogram image as the screenshot was timed during a pictogram image cycle of the aforementioned flashing event. In other embodiments, the symbol may switch between the main ingot game symbol and a “blank” in the game position.

The screen of FIG. 7 also depicts the free spin indicator 51 as showing 3 free spins remaining.

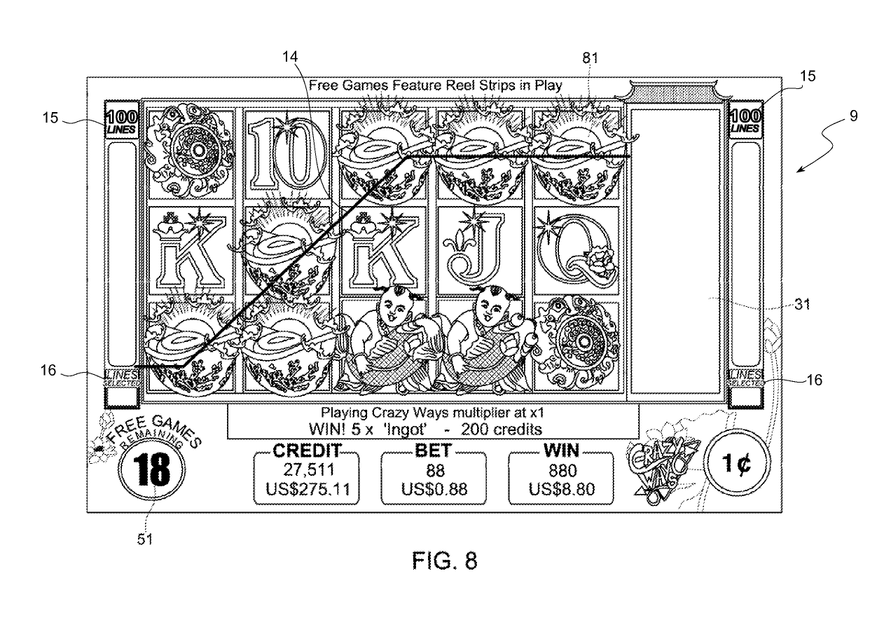

Referring to FIG. 8, where corresponding features have been given the same reference numerals, this embodiment depicts a winning combination of 5 ingots game symbols with no win multiplier symbol being shown on the additional multiplier reel 31. The predetermined prize award associated with 5 ingot game symbols may be 200 credits (which is preferably calculated by comparing the winning combination of game symbols to the paytable). As no win multiplier symbol is shown, the predetermined prize award is multiplied by X1. This produces a final resultant prize award of 200 credits.

The screen of FIG. 8 also depicts the free spin indicator 51 as showing 18 free spins remaining.

Further, any of the embodiments herein described may include a feature in the game of chance, wherein the theoretical average of the various win multiplier values may be different for each betting value or betting option. For example, wherein a player of the game selects a 1¢ game to be played the theoretical average of the win multiplier values may be X1 for that particular game. However, where the bet value of a particular game is increased to 50¢, the theoretical average of the win multiplier values may be increased to X50. The theoretical average in this regard may be the average of the win multiplier values made available to any particular game based on the selected betting option.

Thus, in other words, the present invention in the preferred embodiments provides a greater range of win multiplier values as the player increases the amount of the bet made to play the game (either the base game 8 or the feature game 9). For example, a bet of 1¢ may confer win multiplier values of ×1 and ×2 becoming available on the multiplier reel 31 as appropriate ×1 and ×2 win multiplier symbols, whereas a bet of $1 may confer win multiplier values of ×1, ×2, ×3 and ×5 becoming available on the multiplier reel 31 as appropriate ×1, ×2, ×3 and ×5 win multiplier symbols. Similarly, a $2 bet may confer the same win multiplier values as a $1 bet but increase the frequency of those values/symbols appearing on the multiplier reel 31, thus increasing the chances of a win multiplier value of high value appearing during the game.

In other embodiments, the electronic gaming machine 1 provides one of more jackpot prizes in the base game 8 and/or the feature game 9. In one embodiment, one or more of the jackpot prizes are won where a specific combination of game symbols 10 appears in the player-selected pay lines 14. For example, the player will win a major jackpot if there is a five of a kind of any of the item-themed symbols 10b. Likewise, a minor jackpot will be won by the player if there is a five of a kind of any of the playing card symbols 10a. This type of jackpot is known as a symbol driven jackpot.

In addition, the jackpot prizes can be offered at different tiers or values for certain combinations. Generally, jackpot prizes of higher value may be awarded where it is more difficult to achieve a particular combination of game symbols compared to the combination game symbols required for a jackpot prize of lesser value. For example, the player will win a major bonus instead of the major jackpot if the five of a kind combination is composed of item-themed symbols 10b and at least one wild card or substitute symbol 10c. Similarly, the player will win a minor bonus instead of the minor jackpot 30b if the five of a kind combination is composed of player card symbols 10a and at least one wild card or substitute symbol 10c. This is because the major and minor jackpots require “pure” combinations that do not rely on a substitute or wild card symbol 10c to achieve the five of a kind combination.

In a further embodiment, a trigger event (such as a particular trigger symbol or even a multiplier symbol appearing in the multiplier reel 31) is used as a necessary condition for the player to win a jackpot prize. Hence, a player that achieves a five of a kind combination without the trigger event will not “trigger” the award of the jackpot.

In other embodiments, the display screen 7 provides jackpot information relating to available jackpots or bonus prizes in the game 8, typically by displaying the jackpot information in the upper display area 7b. This can ensure that the jackpot information is available to the player at all times during play of the electronic gaming machine 1.

The jackpot prizes may also include progressive jackpots, fixed jackpots and mystery jackpots. A progressive jackpot prize takes a portion of each bet (typically a set percentage of each bet) made on the electronic gaming machine and thus the amount of the progressive jackpot incrementally increases as more bets are made on the electronic gaming machine 1. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

During play of the base game 8 and/or feature game 9 the electronic game controller will determine whether a trigger event for any of the selected jackpots has occurred, as described above. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, their values are reset and game play of the electronic gaming machine 1 continues as before. The values of the jackpots that have been won can be reset either to a predetermined start value or simply increment upwardly from zero where the won jackpot is a progressive jackpot. In addition, contributions of portions of the bet made to play the game are only made for the selected jackpots that are active. In this way, the player's bets do not contribute towards jackpots that the player cannot win.

In other preferred forms, the base game 8 and feature game 9 need not be alternately displayed on the single video screen 7. Instead, they may be displayed on separate video screens, with the base game 8 appearing in a lower video screen and the feature game 9 in an upper video screen. In other preferred embodiments, the base game 8 and feature game need not be displayed only on the lower video display screen 7a, but can be extended to the upper video screen 7b. Also, the order can be reversed, with the playing area 7a appearing on an upper video screen or upper part of a single video display screen 7 and the information display area 7b appearing on a lower video screen or lower part of a single video display screen. In a further preferred form, the upper video screen may only display the jackpots while the lower video screen displays the base game 8 and the feature game 9.

In another preferred form, the video screen 7 is a touch screen for use in addition to the player-actuatable buttons 5 so as to enable the player to select various features, such as making monetary bets for the base game, select the bet level (such as bet denominations or bet per pay line 14), initiating play of the base and feature games played and responding to any messages or requests issued on the electronic gaming machine 1 by the electronic game controller 4. In this case, the player may control when the reels 12 start spinning and stop spinning by simply touching the reels 12. Control over spinning of the reels 12 can also be implemented through the buttons 6 on the console 3.

In other preferred forms, the jackpot prize can be shared with any other games offered on the electronic gaming machine (as in multi-game gaming machines) or games offered on separate electronic gaming machines. In one preferred form, one of the jackpot prizes comprises a mystery jackpot. That is, none of the symbols in the game trigger the jackpot; hence the triggering event is a “mystery”. By way of comparison, a standard jackpot is typically symbol driven in that a particular combination of symbols must occur in the game to trigger the standard jackpot. The trigger event for the mystery jackpot can be one randomly generated by the electronic game controller 4 for each play of the game 8. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the mystery jackpot, which could also be a progressive jackpot prize. It will be appreciated that this manner of determining the trigger event may also be used to determine whether the feature game 9 is triggered in the base game 8.

One or more of the jackpot prizes in a further preferred form takes the form of a grand progressive jackpot confined to the electronic gaming machine 1. In this case, the jackpot is a so called “standalone” progressive jackpot. However, in another preferred form, the grand progressive jackpot is configured to be part of a wide area or in-house link progressive jackpot. In other words, the grand progressive jackpot can be awarded on a group of networked gaming machines in a specified area or a group of specified electronic gaming machines that are linked together for jackpot purposes (usually via a central jackpot controller). The jackpot prizes can also be shared with any other games offered on the same electronic gaming machine 1 (as in multi-game gaming machines).

Furthermore, the embodiments of the invention have been described as providing a standard 5×3 set of reels 12 for the base game 8. However, it will be appreciated that in other embodiments, the size and shape of the reels 12. For example, the array 11 could take any number of different shapes, such as triangular, circular, square, hexagonal, hemi-spherical or other polygonal shapes. Alternatively, the arrays 11 could have an unequal number of rows or columns. For example, the reels 12a, 12b could have three rows, but the reels 12c to 12e could have four rows.

Similarly, the multiplier reel 31 may also take a different shape or size than illustrated in the preferred embodiments. For example, the multiplier reel 31 is located above the array 11. In another example, the multiplier reel 31 can be a curved reel to one side or above the array 11. In a further example, the reel 31 comprises a single game position 13.

In addition, in other embodiments the winning combinations comprise “ways” instead of winning combinations of randomly selected symbols in the game positions 13 that form the player-selected lines 14. It will be understood by those skilled in the art that “ways” comprise all possible combinations of predetermined game or symbol positions. In the case of a reel set, the ways would comprise all possible combinations of predetermined symbol positions, where there is at least one symbol position from each reel or column in each possible combination. Hence, for an array having n rows and m columns, the number of possible combinations or ways is n^{m}. For example, in a reel set of 3 rows and 5 columns, there would be 243 ways (3⁵). The number of ways can also be selected either individually or on a group basis. For example, a player may be offered an opportunity to select one or more reels (or symbols positions in reels), and on the basis of the selected number of reels/symbol positions the number of ways is calculated by the electronic game controller. Thus, a selection of two reels, for example, would result in the calculation of 9 ways (i.e. 3² ways), as there are three rows for each reel. Similarly, the selection of three reels would result in 27 ways (i.e. 3³ ways) and the selection of four reels would result in 81 ways (i.e. 3⁴ ways).

While the preferred embodiment of the invention has been described in relation to both a base game 8 and a feature game 9, those skilled in the art will appreciate that the use of the multiplier reel 31 and win multiplier symbols 41 can readily be applied to the base game alone or a feature game alone.

While the same game format can be essentially used across the base game and feature game, it will be appreciated that the game format may vary across both the base game and feature game. For example, the feature game 9 could adopt a different format of cells and/or use an entirely different set of game symbols, or a mixture of game symbols from the base game and different game symbols. In another example, the base game may be a wheel-type game or a four reel game and the feature game may be a standard five reel game. Similarly, the base game and feature game may each have different game symbols, game rules and pay tables that are unique to each game. Also, the arrangement of the base game 8 and the feature game 9 is not limited to a set of reels or columns, but could take other forms, such as non-rectangular arrays (i.e. arrays that do not comprise rows and columns). For example, where the array is circular, the predetermined game positions can take the form of pie-shaped slices or wedges.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game.

In other embodiments of the invention, the base game 8 or the feature game 9 may include game enhancing symbols that confer game enhancing elements. The award of game enhancing elements can be done by way of a sixth reel or the appearance of game enhancing symbols in the reels 12a to 12e.

The types of game enhancing elements include fixed monetary prizes, “Held Reels”, “×10 Multiplier” (applicable to the prize awarded by the base game for the five of a kind trigger combination and/or to the total amount of the bet or credits bet per pay line), “10 Free Spins/Games”, progressive symbols and changing the function of a standard game symbol 10a, 10b into a substitute symbol in addition to any displayed substitute symbols 10c. Held columns or reels typically involve the column or reel to only display wild/substitute symbols, thus enhancing the probability of achieving a predetermined combination. Progressive symbols award a prize is awarded upon a certain number of progressive symbols are accumulated by the player over a number of games played on the gaming machine. Other examples include:
i) symbols that award a predetermined number of free plays of said game, such as 8, 10 or 15 free spins or games;
ii) win multiplier symbols that multiply the amount of any win from one of said predetermined winning combinations;
iii) “wild” symbols that cause the display of substitute symbols in randomly selected symbol positions;
iv) bonus symbols that awards a bonus prize, either as a monetary amount or as a bonus credit;
v) wild multiplier symbols that cause the display of substitute symbols on the array 11 and multiplies the amount of any win from one of said predetermined winning combinations;
vi) bonus wild symbols that cause the display of substitute symbols on the array 11 and awards a bonus prize;
vii) symbols that cause the award of additional free plays of said game;
viii) symbols that cause one or more of said symbol positions to be held static (typically one or more reels 12a to 12e) and display substitute symbols on the array 11;
ix) symbols that cause the same game symbol to be stacked in a group of symbol positions, typically the group being one or more reels 12a to 12e;
x) symbols that cause the display of new game symbols on the array 11;
xi) “reveal” symbols that cause a game symbol to reveal another game symbol;
xii) “replacement” symbols that cause one or more game symbols to be replaced by other game symbols in the array 11;
xiii) Bonus Prize of 5× bet, 10× bet or 25× bet (the total amount of the bet or credits bet per pay line);
xiv) All royal card symbols change to wilds (substitute symbols) on reels 2, 3 and 4 (i.e. reels 12b, 12c and 12d) of the array 11;
xv) All picture symbols change to wilds on reels 2, 3 and 4 (i.e. reels 12b, 12c and 12d) of the array 11;
xvi) All symbols on reels 2 and 4 (i.e. reels 12b and 12d) of the array 11 change to wild symbols; and
xvii) All symbols on reels 1 and 5 (i.e. reels 12a and 12e) of the array 11 change to wild symbols.

These game enhancing symbols do not modify the function or value of the game symbols 10 that appear on the arrays 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

In other preferred embodiments, additional game enhancing symbols include the award of points or tokens that lead to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

In some embodiments, the electronic gaming machine comprises a housing and an input device. The input device comprises one or more buttons 6 on the housing, the buttons being in electronic communication with the electronic game controller 4 to transmit player commands to the electronic game controller. In some embodiments, the buttons 6 need not be arranged on the console 3. Alternatively or additionally, the input device comprises a touch sensitive surface on the display 7 for receiving player commands, the touch sensitive surface being in electronic communication with the electronic game controller 4 to transmit player commands to the electronic game controller. The housing may also comprise in some embodiments a value transfer mechanism for paying the prizes to the player using value in an amount equal to an awarded prize. More preferably, the value transfer mechanism also receives value from the player to initiate the bet.

It will further be appreciated that any of the features in the preferred embodiments of the invention can be combined together and are not necessarily applied in isolation from each other. For example, the feature of the player being able to selectively starting or stopping spinning of the reels 12 and the feature of a curved multiplier reel can be combined into a single electronic gaming machine. Similar combinations of two or more features from the above described embodiments or preferred forms of the invention can be readily made by one skilled in the art.

By providing a range of win multiplier values that increase the value of any prize awarded for a winning combination of symbols and are related to the betting option selected by the player, the invention introduces a variety in game play and game mechanics to the player, thus increasing the player's excitement and retaining his or her interest in playing the same electronic gaming machine. Also, the invention in its preferred embodiments further increases the player's interest and participation in the electronic gaming machine as the player sees a direct connection between the selected betting option and the range of win multiplier values available to the player. The invention also adds greater value to the player in terms of providing a greater reward to increasing the betting option as either win multiplier values of greater value become available and/or an increased probability of obtaining a win multiplier value. This is unlike a conventional electronic gaming machine, which ties the prize values to specific combinations of symbols and only multiplies those values according to the amount of the bet. All these advantages of the invention result in the player being more likely to retain interest in continuing to play the same electronic gaming machine due to the variation in the game play on the electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine adapted for playing a game of chance, comprising:
a housing having a display for displaying said game of chance;
an electronic game controller in electronic communication with said display for controlling the display of said game of chance on said display; and
an input device for receiving commands from said player to operate said electronic gaming machine and initiate play of said game on said display, said input device being in electronic communication with said electronic game controller;
wherein said electronic game controller in response to a command from said player via said input device transmits a signal to said display to display said game of chance, said command comprising a selection of at least a first betting option and a second betting option, wherein each said betting option has a respective unique bet value associated with participation in the game;
wherein said electronic game controller randomly determines at least one win multiplier value from a plurality of predetermined win multiplier values;
wherein said electronic game controller associates at least one winning event associated with a winning combination, wherein the player receives a prize calculated by: the randomly determined win multiplier value being multiplied by a predetermined prize award associated with the winning combination, and
wherein a theoretical average multiplier value associated with said first betting option is different to a theoretical average win multiplier value associated with said second betting option.

2. The electronic gaming machine of claim 1, wherein the predetermined prize award does not vary between respective betting options.

3. The electronic gaming machine of claim 1, wherein the predetermined win multiplier values include at least one 1× multiplier value.

4. The electronic gaming machine of claim 1, wherein said theoretical average multiplier value is calculated based on the betting option selected by said player.

5. The electronic gaming machine of claim 1, wherein said win multiplier value is applied to the predetermined prize awards for all winning combinations appearing in a single play of said game.

6. The electronic gaming machine of claim 1, wherein said win multiplier value is applied to the predetermined prize awards for a selection of predetermined winning combinations appearing in a single play of said game.

7. The electronic gaming machine of claim 1, wherein a ratio of each bet value associated with each betting option to each respective theoretical average multiplier value, is the same for all betting options.

8. The electronic gaming machine of claim 1, wherein said at least one win multiplier value is displayed as a win multiplier symbol forming part of said game, said win multiplier symbol being randomly displayed.

9. The electronic gaming machine of claim 8, wherein said game of chance comprises game symbols arranged into an array of predetermined game positions to define a plurality of reels where predetermined winning combinations of randomly selected game symbols comprise predetermined winning events and said at least one win multiplier symbol is displayed on at least one reel, wherein the said at least one reel does not display game symbols other than win multiplier symbols.

10. The electronic gaming machine of claim 8, wherein the probability of said at least one win multiplier symbol being displayed on said at least on reel is different between at least the first and second betting options.

11. The electronic gaming machine of claim 1, wherein the predetermined win multiplier values comprises more than one occurrence of a 1× multiplier value.

12. The electronic gaming machine of claim 1, wherein more than one win multiplier symbol is displayed on said display.

13. The electronic gaming machine of claim 12, wherein said prize comprises the predetermined prize award multiplied by the win multiplier values associated with all win multiplier symbols displayed on said display.

14. The electronic gaming machine of claim 1, wherein only win multiplier values greater than 1 are displayed on said display.

15. An electronic gaming machine adapted for playing a game of chance, comprising:
a housing having a display for displaying said game of chance;
an electronic game controller in electronic communication with said display for controlling the display of said game of chance on said display; and
an input device for receiving commands from said player to operate said electronic gaming machine and initiate play of said game on said display, said input device being in electronic communication with said electronic game controller;
wherein said electronic game controller in response to a command from said player via said input device transmits a signal to said display to display said game of chance, said command comprising a selection at least a first betting option and a second betting option selectable by a player, wherein each betting option has a respective bet value associated with participation in the game;
wherein said electronic game controller randomly determines at least one win multiplier value from a plurality of predetermined win multiplier values;
said game of chance comprising at least one winning event, wherein the player receives a prize and wherein the prize is calculated by said randomly determined win multiplier value multiplied by a predetermined prize award; and
wherein said electronic game controller varies the randomly determined win multiplier value based on the selected betting option.

16. The electronic gaming machine of claim 15, wherein the predetermined prize award does not vary between respective betting options.

17. The electronic gaming machine of claim 15, wherein the predetermined win multiplier values includes at least one 1× multiplier.

18. The electronic gaming machine of claim 15, wherein a theoretical average multiplier value is different for each betting option.

19. The electronic gaming machine of claim 15, wherein said win multiplier value is applied to the predetermined prize awards for all winning combinations appearing in a single play of said game.

20. The electronic gaming machine of claim 15, wherein said win multiplier value is applied to the predetermined prize awards for a selection of predetermined winning combinations appearing in a single game.

21. The electronic gaming machine of claim 15, wherein a ratio of each bet value associated with each betting option to each respective theoretical average multiplier value is the same for all betting options.

22. The electronic gaming machine of claim 15, wherein said at least one win multiplier value is displayed as a win multiplier symbol forming part of said game, said win multiplier symbol being randomly displayed.

23. The electronic gaming machine of claim 22, wherein said game of chance comprises game symbols arranged into an array of predetermined game positions to define a plurality of reels where predetermined winning combinations of randomly selected game symbols comprise predetermined winning events and said at least one win multiplier symbol is displayed on at least one reel, wherein the said at least one reel does not display game symbols other than win multiplier symbols.

24. The electronic gaming machine of claim 22, wherein the probability of said at least one win multiplier symbol being displayed on said at least one reel is different between at least the first and second betting options.

25. The electronic gaming machine of claim 15, wherein the predetermined win multiplier values comprise more than one occurrence of a 1× multiplier value.

26. The electronic gaming machine of claim 15, wherein more than one win multiplier symbol is displayed on said display.

27. The electronic gaming machine of claim 26, wherein the prize comprises the predetermined prize award multiplied by the win multiplier values associated with all win multiplier symbols displayed on said display.

28. The electronic gaming machine of claim 15, wherein only win multiplier values greater than 1 are displayed on said display.

29. The electronic gaming machine of claim 1, wherein said game of chance comprises an array of predetermined symbol positions arranged into rows and columns, and said winning combination comprises all possible combinations of symbol positions, where there is at least one symbol position from each column in each possible combination.
